(19) United States
(12) Patent Application Publication
(10) Pub. No.: US 2023/0130779 A1
(43) Pub. Date: Apr. 27, 2023

(54) METHOD AND APPARATUS WITH NEURAL NETWORK COMPRESSION

(71) Applicants: Samsung Electronics Co., Ltd, Suwon-si (KR); Korea Advanced Institute of Science and Technology, Daejeon (KR)

(72) Inventors: Jun-Woo JANG, Suwon-si (KR); Jaekang SHIN, Daejeon (KR); Lee-Sup KIM, Daejeon (KR); Seungkyu CHOI, Daejeon (KR)

(73) Assignees: Samsung Electronics Co., Ltd., Suwon-si (KR); Korea Advanced Institute of Science and Technology, Daejeon (KR)

(21) Appl. No.: 17/892,481

(22) Filed: Aug. 22, 2022

(30) Foreign Application Priority Data
Oct. 26, 2021 (KR) 10-2021-0143629
Oct. 26, 2021 (KR) 1020210143629

(51) Int. Cl. G06N 3/08; G06N 3/04

(52) U.S. Cl. CPC G06N 3/082; G06N 3/0454

(57) ABSTRACT

A method with neural network compression includes: generating a second neural network by fine-tuning a first neural network, which is pre-trained based on training data, for a predetermined purpose; determining delta weights corresponding to differences between weights of the first neural network and weights of the second neural network; compressing the delta weights; retraining the second neural network updated based on the compressed delta weights and the weights of the first neural network; and encoding and storing the delta weights updated by the retraining of the second neural network.

### CROSS-REFERENCE TO RELATED APPLICATIONS

This application claims the benefit under 35 USC § 119(a) of Korean Patent Application No. 10-2021-0143629, filed on Oct. 26, 2021 in the Korean Intellectual Property Office, the entire disclosure of which is incorporated herein by reference for all purposes.

### BACKGROUND

### 1. Field

The following description relates to a method and apparatus with neural network compression.

### 2. Description of Related Art

Computer vision (CV) tasks may be implemented using deep neural networks (DNNs), and applications using DNNs may also be diversified. A DNN model for CV may be trained to process a single task. For image classification, for example, a DNN model may not be trained as a universal model for classifying classes of all objects, but rather may be trained to classify a set of classes selected for a predetermined purpose (e.g., to perform a single predetermined task) and the trained model may be referred to as a task-specific model. In general, a task-specific model may be trained through transfer learning that fine-tunes a base model that is pre-trained using a large volume of training data to a predetermined task. In this case, as the number of tasks increases, the number of task-specific models or the values of parameters may increase linearly. However, methods and apparatuses implementing a plurality of task-specific models may not efficiently store and load the plurality of task-specific models.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method with neural network compression include: generating a second neural network by fine-tuning a first neural network, which is pre-trained based on training data, for a predetermined purpose; determining delta weights corresponding to differences between weights of the first neural network and weights of the second neural network; compressing the delta weights; retraining the second neural network updated based on the compressed delta weights and the weights of the first neural network; and encoding and storing the delta weights updated by the retraining of the second neural network.

The encoding and storing of the delta weights may include: determining whether to terminate the retraining of the second neural network based on a preset accuracy standard with respect to the second neural network; and encoding and storing the delta weights updated by retraining of the second neural network based on a determination to terminate the retraining of the second neural network.

The method may include, in response to a determination not to terminate the retraining of the second neural network, iteratively performing the compressing of the delta weights and the retraining of the second neural network updated based on the compressed delta weights and the weights of the first neural network.

The encoding and storing of the delta weights may include: encoding the delta weights by metadata comprising position information of non-zero delta weights of the delta weights; and storing the metadata corresponding to the second neural network.

The compressing of the delta weights may include performing pruning to modify a weight, which is less than or equal to a predetermined threshold, of the delta weights to be 0.

The compressing of the delta weights may include performing quantization to reduce the delta weights to a predetermined bit-width.

The method may include generating the second neural network, which is trained to perform the predetermined purpose, based on the delta weights, which are encoded and stored, and the weight of the first neural network.

In another general aspect, a method with neural network compression includes: generating a plurality of task-specific models by fine-tuning a base model, which is pre-trained corresponding to a plurality of training data sets for a plurality of purposes; for each of the plurality of task-specific models, determining delta weights corresponding to differences between weights of the base model and weights of the task-specific model; for each the plurality of task-specific models, compressing the determined delta weights based on a preset standard corresponding to the task-specific model; and compressing and storing the plurality of task-specific models based on the compressed delta weights corresponding to the plurality of task-specific models.

The compressing of the determined delta weights may include performing pruning to modify a weight, which is less than or equal to the predetermined threshold, of the delta weights to be 0.

The compressing of the determined delta weights may include performing quantization to reduce the delta weights to a predetermined bit-width.

The compressing and storing of the plurality of task-specific models may include: for each of the plurality of task-specific models, retraining the task-specific model updated based on the weights of the base model and the compressed delta weights corresponding to the task-specific model; and for each of the plurality of task-specific models, encoding and storing delta weights corresponding to the task-specific model updated by the retraining.

The encoding and storing of the delta weights may include: encoding the delta weights by metadata comprising position information of non-zero delta weights of the delta weights; and storing the metadata corresponding to the task-specific models.

The preset standard may include either one or both of a standard on a pruning ratio and a standard on a quantization bit-width.

In another general aspect, one or more embodiments include a non-transitory computer-readable storage medium storing instructions that, when executed by one or more processors, configure the one or more processors to perform any one, any combination, or all operations and methods described herein.

In another general aspect, an apparatus with neural network compression includes: one or more processors configured to: generate a second neural network by fine-tuning a first neural network, which is pre-trained based on training data, for a predetermined purpose; determine delta weights corresponding to differences between weights of the first neural network and weights of the second neural network; compress the delta weights; retrain the second neural network updated based on the compressed delta weights and the weights of the first neural network; and encode and store the delta weights updated by retraining of the second neural network.

For the encoding and storing of the delta weights, the one or more processors may be configured to: determine whether to terminate the retraining of the second neural network based on a preset accuracy standard with respect to the second neural network; and encode and store the delta weights updated by retraining of the second neural network based on a determination to terminate the retraining of the second neural network.

The one or more processors may be configured to, in response to a determination not to terminate the retraining of the second neural network, iteratively perform the compressing of the delta weights and the retraining of the second neural network updated based on the compressed delta weights and the weights of the first neural network.

In another general aspect, a method with neural network compression includes: determining delta weights based on differences between weights of a pre-trained base neural network and weights of a task-specific neural network generated by retraining the pre-trained base neural network for a predetermined task; updating the task-specific neural network by compressing the delta weights; updating the compressed delta weights by retraining the updated task-specific neural network; and encoding and storing the updated delta weights.

The updating of the task-specific neural network may include summing the weights of the base neural network and the compressed delta weights.

The method may include: updating the pre-trained base neural network based on the stored delta weights; and performing the predetermined task by implementing the updated base neural network.

The stored delta weights may be stored in an external device, and the implementing of the updated base neural network may include loading the stored delta weights by a user device.

Other features and aspects will be apparent from the following detailed description, the drawings, and the claims.

### BRIEF DESCRIPTION OF THE DRAWINGS

FIG. 1 illustrates an example of an operation of a method of compressing a neural network.

FIG. 2 illustrates an example of a method of obtaining a delta weight.

FIG. 3 illustrates an example of a method of compressing a delta weight.

FIG. 4 illustrates an example of a method of storing a delta weight by encoding.

FIG. 5 illustrates an example of a process of re-training a second neural network and an operation of iteratively performing a process of compressing a delta weight.

FIG. 6 illustrates an example of an operation of a method of compressing a neural network corresponding to models by a plurality of tasks obtained from a base model.

FIG. 7 illustrates an example of a configuration of a device.

FIG. 8 illustrates an example of a hardware structure of a model performing a method of compressing a neural network.

FIG. 9 illustrates an example of a hardware structure of a model performing a method of compressing a neural network.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known, after an understanding of the disclosure of this application, may be omitted for increased clarity and conciseness.

The terminology used herein is for the purpose of describing particular examples only and is not to be limiting of the present disclosure. As used herein, the singular forms “a,” “an,” and “the” are intended to include the plural forms as well, unless the context clearly indicates otherwise. As used herein, the term “and/or” includes any one and any combination of any two or more of the associated listed items. As used herein, the terms “include,” “comprise,” and “have” specify the presence of stated features, integers, steps, operations, elements, components, numbers, and/or combinations thereof, but do not preclude the presence or addition of one or more other features, integers, steps, operations, elements, components, numbers, and/or combinations thereof. The use of the term “may” herein with respect to an example or embodiment (for example, as to what an example or embodiment may include or implement) means that at least one example or embodiment exists where such a feature is included or implemented, while all examples are not limited thereto.

Although terms of “first” or “second” are used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween. Likewise, expressions, for example, “between” and “immediately between” and “adjacent to” and “immediately adjacent to” may also be construed as described in the foregoing.

Unless otherwise defined, all terms used herein including technical or scientific terms have the same meaning as commonly understood by one of ordinary skill in the art to which examples belong after and understanding of the present disclosure. It will be further understood that terms, such as those defined in commonly-used dictionaries, should be interpreted as having a meaning that is consistent with their meaning in the context of the relevant art and the present disclosure, and will not be interpreted in an idealized or overly formal sense unless expressly so defined herein.

Hereinafter, example embodiments will be described in detail with reference to the accompanying drawings. When describing the example embodiments with reference to the accompanying drawings, like reference numerals refer to like components and a repeated description related thereto will be omitted.

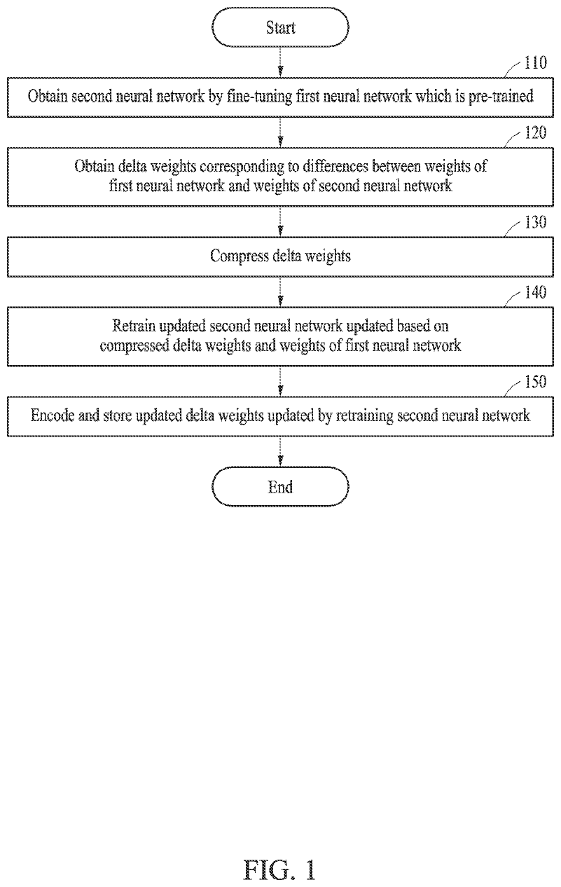

FIG. 1 illustrates an example of an operation of a method of compressing a neural network.

Referring to FIG. 1, a method of compressing a neural network may include operation 110 of obtaining a second neural network (e.g., a task-specific neural network) by fine-tuning a first neural network which is pre-trained, operation 120 of obtaining delta weights corresponding to differences between weights of the first neural network and weights of the second neural network, operation 130 of compressing the delta weights, operation 140 of retraining the second neural network compressed based on the compressed delta weights and the weights of the first neural network, and operation 150 of encoding and storing the delta weights updated based on retraining of the compressed second neural network.

Operation 110 may include an operation of obtaining the second neural network by fine-tuning the first neural network which is pre-trained based on training data for a predetermined purpose (e.g., a predetermined task). The first neural network may correspond to a pre-trained base model. The second neural network may refer to a network obtained by fine-tuning the first neural network based on a predetermined task and may correspond to a task-specific model. The second neural network may include a fine-tuned weight of the first neural network based on training data for a predetermined purpose.

The fine-tuning may include an operation of newly training the pre-trained first neural network based on training data for a predetermined purpose. For example, in fine-tuning, a portion of layers of the first neural network may be replaced or updated, and the second neural network may be obtained by newly training the first neural network of which the portion of layers is replaced or updated. In addition, for example, in fine-tuning, a portion of layers of the first neural network may be newly trained, and all the layers may be newly trained. The training data for a predetermined purpose used in fine-tuning may be at least partially different from the training data used in training of the first neural network.

Operation 120 may include an operation of obtaining delta weights corresponding to differences between weights of the first neural network and weights of the second neural network. For example, the delta weights may be obtained by subtracting the weights of the first neural network from the weights of the second neural network, which is obtained by fine-tuning.

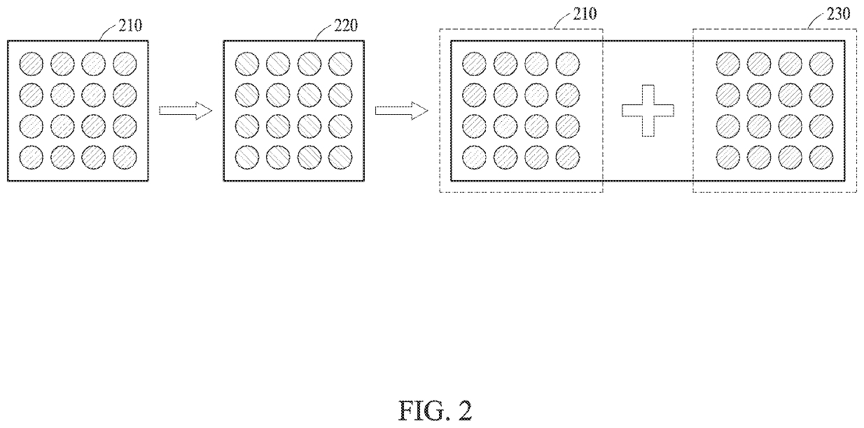

For example, referring to FIG. 2, the second neural network including modified weights 220 may be obtained by fine-tuning the first neural network including weights 210. The weights 220 of the second neural network may be separated into the weights 210 of the first neural network and delta weights 230. The delta weights 230 may be obtained by subtracting the weights 210 of the first neural network from the weights 220 of the second neural network.

Operation 130 may include an operation of compressing the delta weights using a compression technique to reduce data size of the delta weights. For example, operation 130 of compressing the delta weights may include an operation of performing pruning to modify a weight, which is less than or equal to a predetermined threshold, to be 0 among the delta weights. Pruning may be performed based on a preset pruning ratio. As another example, or additionally, operation 130 of compressing the delta weights may include an operation of performing quantization to reduce the delta weights to a predetermined bit-width.

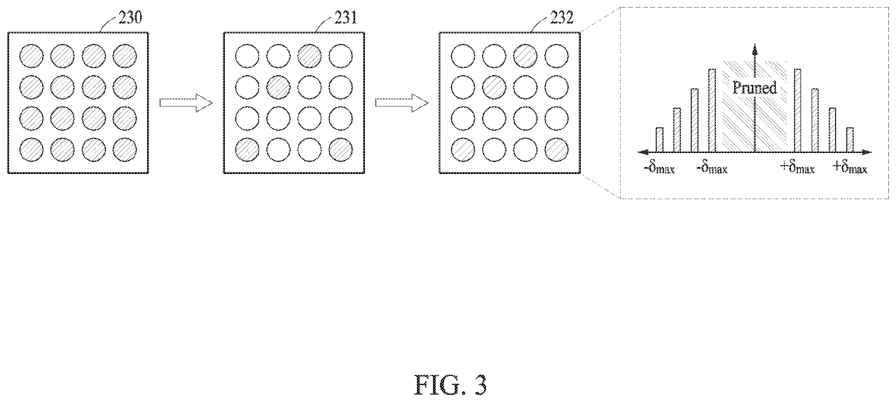

Operation 130 of compressing the delta weights may include an operation of performing pruning to modify a weight, which is less than or equal to a predetermined threshold, to be 0 among the delta weights and an operation of performing quantization, based on pruning, to reduce non-zero delta weights to a predetermined bit-width. For example, referring to FIG. 3, compressed delta weights 231 (e.g., pruned delta weights) may be obtained by modifying a weight, which is less than or equal to a predetermined threshold, among the delta weights 230 to be 0 by pruning. Compressed delta weights 232 (e.g., quantized pruned delta weights) may be obtained by quantizing non-zero weights of the compressed delta weights 231 compressed by pruning to a predetermined bit-width.

Operation 140 may include an operation of retraining the second neural network updated based on the compressed delta weights and the weights of the first neural network. An updated second neural network of which weights are updated may be obtained by summing the weights of the first neural network and the compressed delta weights. The updated second neural network may be retrained based on training data for a predetermined purpose. The training data for a predetermined purpose may correspond to the training data used in fine-tuning of the first neural network in operation 110. The weights of the second neural network may be updated by a process of retraining.

A non-zero delta weight of the updated second neural network may be updated by retraining. For example, among the weights of the updated second neural network, a weight which is the same (or substantially the same) as a weight of the first neural network (e.g., a weight corresponding to a zero-valued delta weight) may be not updated, and a weight which is different (or substantially different) from a weight of the first neural network (e.g., a weight corresponding to a non-zero delta weight) may be updated and a value of the non-zero delta weight may be modified.

The delta weights updated in operation 150 may be obtained based on differences between the updated weights of the updated second neural network in operation 140 and the weights of the first neural network. Since the weights of the updated second neural network may be modified by retraining, the delta weights may also be modified (e.g., in operation 140, the modifying or updating of the weights of the updated second neural network may include modifying or updating the delta weights). The updated delta weights may be encoded and stored.

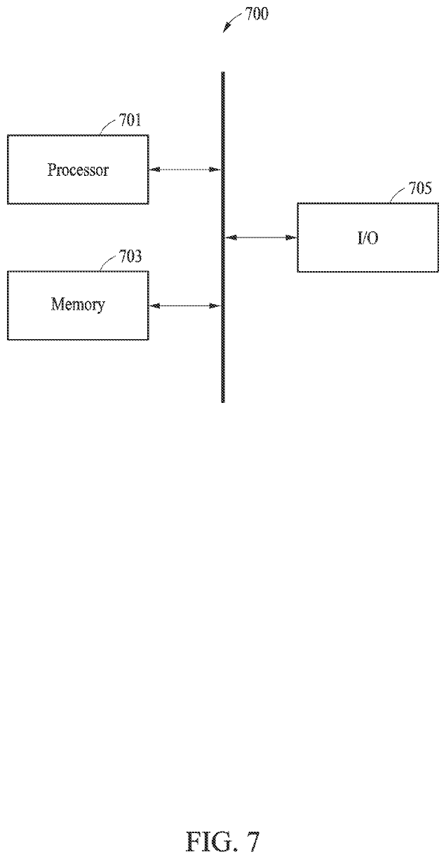

Operation 150 of encoding and storing the delta weights may include an operation of encoding the delta weights by metadata including position information of non-zero delta weights of the delta weights and an operation of storing (e.g., in memory 703 of FIG. 7) the metadata corresponding to the second neural network. The metadata may refer to data including position information and values of non-zero delta weights of the delta weights, and may correspond to a small volume of data compared to all delta weights including zeros. A memory size required to store delta weights may be reduced by encoding and storing the compressed delta weights, instead of storing all delta weights.

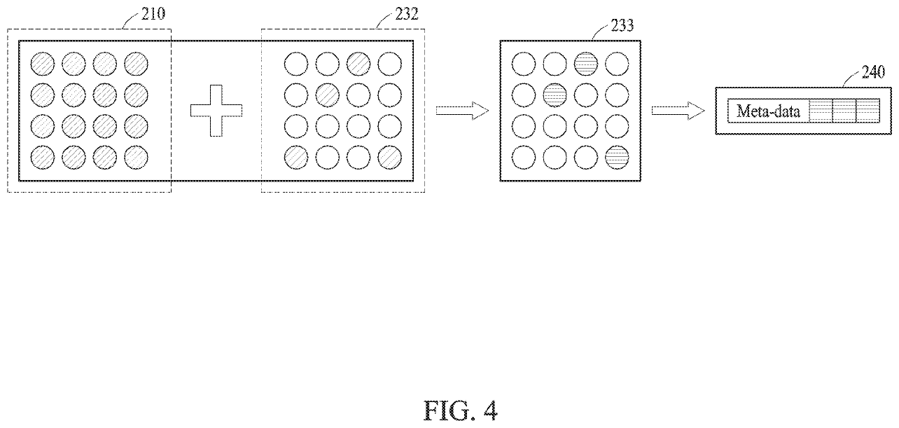

For example, referring to FIG. 4, an updated second neural network updated based on the weights 210 of the first neural network and the compressed delta weights 232 obtained by compressing the delta weights may be obtained, and updated delta weights 233 updated by retraining the updated second neural network may be obtained. The updated delta weights 233 may be encoded by metadata 240 including position information of non-zero delta weights of the updated delta weights 233. The metadata 240 may include position information as well as values of the non-zero delta weights.

A process of retraining the second neural network and a process of compressing the delta weights may be iteratively performed based on a preset accuracy standard for the second network.

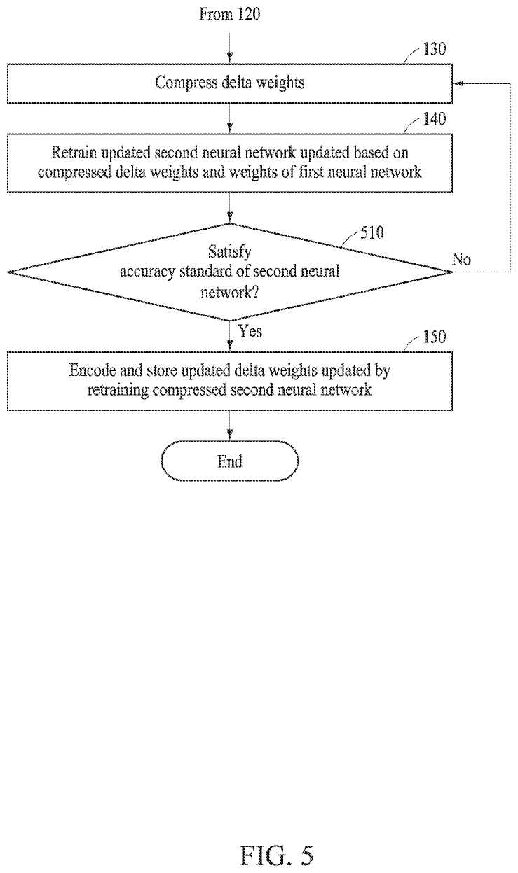

For example, referring to FIG. 5, operation 150 of encoding and storing the updated delta weights may further include operation 510 of determining whether to terminate retraining of the second neural network based on a preset accuracy standard for the second neural network. The accuracy standard may include a standard based on a difference between an output of the second neural network and ground truth data. The retraining may be performed to correct an error, caused by compression of delta weights, in an inference result of the second neural network and may be determined to be terminated in response to a preset accuracy standard of the second neural network being satisfied. In other words, based on a determination to terminate retraining of the second neural network, operation 150 may include encoding and storing the updated delta weights by retraining of the second neural network. Based on a determination not to terminate retraining of the second neural network, operation 150 may further include an operation of iteratively performing operation 130 of compressing the delta weights and operation 140 of retraining the second neural network updated based on the compressed delta weights and the weights of the first neural network.

A method of compressing a neural network may further include an operation of obtaining a second neural network, which is trained to perform a predetermined purpose based on delta weights which are encoded and stored, and weights of a first neural network. In other words, even when the entire second neural network is not stored in a memory, the second neural network may be obtained from the weights of the first neural network and encoded data of the delta weights corresponding to a stored second neural network.

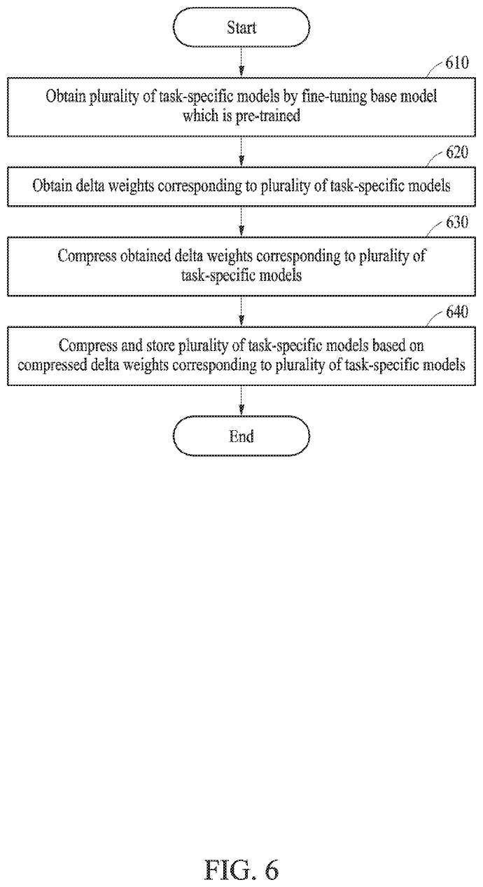

FIG. 6 illustrates an example of an operation of a method of compressing a neural network corresponding to models by a plurality of tasks obtained from a base model.

Referring to FIG. 6, the method of compressing a neural network may include operation 610 of obtaining a plurality of task-specific models by fine-tuning a pre-trained base model, operation 620 of obtaining delta weights corresponding to the plurality of task-specific models, operation 630 of compressing the obtained delta weights corresponding to the plurality of task-specific models, and operation 640 of compressing and storing the plurality of task-specific models based on the compressed delta weights corresponding to the plurality of task-specific models.

Operation 610 may include an operation of obtaining a plurality of task-specific models by fine-tuning a pre-trained base model corresponding to a plurality of training data sets for a plurality of purposes. By fine-tuning one base model using different training data sets, a plurality of task-specific models, which are trained to perform different-purposed tasks, may be obtained. The base model may correspond to the above-described first neural network, and the task-specific model may correspond to the above-described second neural network.

Operation 620 of obtaining the delta weights and operation 630 of compressing the delta weights may be performed for a plurality of task-specific networks.

Operation 620 may include, for the plurality task-specific models, an operation of obtaining delta weights corresponding to differences between weights of the base model and weights of the task-specific models. For example, operation 620 may include, for each of the plurality task-specific models, an operation of obtaining delta weights corresponding to differences between weights of the base model and weights of the task-specific model. In other words, Operation 620 may correspond to an operation of performing operation 120 of obtaining the delta weights described with reference to FIG. 1 for the plurality of task-specific models.

Operation 630 may include an operation of compressing the obtained delta weights based on a preset standard corresponding to the task-specific models. The preset standard may be a standard on a degree of compressing the delta weights, and, for example, may include at least one of a standard on a pruning ratio and a standard on a quantization bit-width. Operation 630 may correspond to an operation of performing operation 130 of compressing the delta weights described with reference to FIG. 1 for each of the plurality of task-specific models. For example, operation 630 may include an operation of performing pruning to modify a weight, which is less than or equal to a predetermined threshold, to be 0 among the delta weights. As another example, or additionally, operation 630 may include an operation of performing quantization to reduce the delta weights to a predetermined bit-width.

Operation 640 may include, for the plurality of task-specific models, an operation of retraining updated task-specific models updated based on the weights of the base model and the compressed delta weights corresponding to the task-specific models and an operation of encoding and storing delta weights corresponding to the updated task-specific models by retraining. In other words, operation 640 may correspond to an operation of performing operation 140 of retraining the updated second neural network described with reference to FIG. 1 and operation 150 of encoding and storing the delta weights updated by retraining for the task-specific models corresponding to the second neural network.

As described above, a process of retraining the task-specific models and a process of compressing the delta weights may be iteratively performed based on a preset accuracy standard for the task-specific models.

An operation of encoding and storing the delta weights corresponding to the updated task-specific models updated by retraining may include an operation of encoding the delta weights by metadata including position information of non-zero delta weights of the delta weights and an operation of storing the metadata corresponding to the task-specific models. In other words, instead of storing all the task-specific models, encoded data of the delta weights corresponding to the task-specific models may be stored.

FIG. 7 illustrates an example of a configuration of a device.

Referring to FIG. 7, a device 700 may include a processor 701 (e.g., one or more processors), a memory 703 (e.g., one or more memories), and an input/output (I/O) device 705. The device 700 may be or include, for example, a user device (e.g., a smartphone, a personal computer (PC), a tablet PC, etc.) and/or a server.

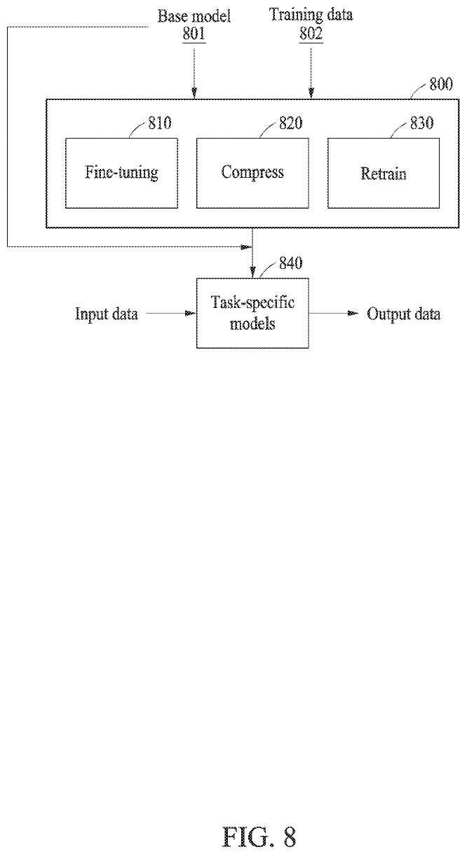

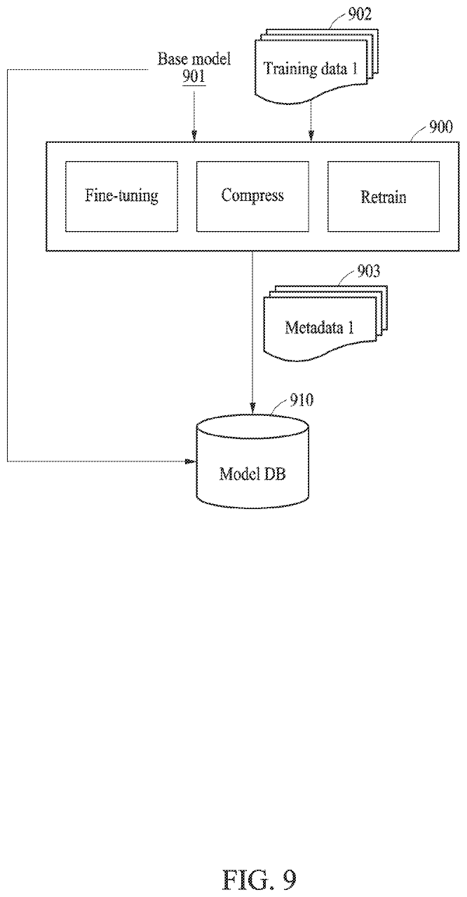

The device 700 may be or include a device for performing the above-described method of compressing a neural network. The processor 701 may perform any one, any combination of any two or more, or all of the operations and methods described with reference to FIGS. 1 through 6. For example, the processor 701 may perform the above-described operation of the method of compressing a neural network of FIG. 1. A non-limiting example hardware structure to perform the above-described operation of the method of compressing a neural network of FIG. 1 is described with reference to FIG. 8. As another example, the processor 701 may perform the above-described operation of the method of compressing a neural network corresponding to a plurality task-specific models obtained from a base model of FIG. 6. A non-limiting example hardware structure to perform the above-described operation of the method of compressing a neural network of FIG. 6 is described with reference to FIG. 9.

The memory 703 may store the method of compressing a neural network, related information thereof, data required to perform the method of compressing a neural network, and/or data generated by performing the method of compressing a neural network. For example, the memory 703 may store a base model or weights of the first neural network, and encoded data of delta weights corresponding to the second neural network. The memory 703 may be a volatile memory or a non-volatile memory.

The device 700 may be connected to an external device (e.g., a PC or a network) through the I/O device 705 to exchange data with the external device. For example, the device 700 may receive a speech signal via the I/O device 705 and may output text data corresponding to the speech signal as a result of speech recognition of the speech signal.

The memory 703 may store a program implementing the above-described method of compressing a neural network. The processor 701 may execute a program stored in the memory 703 and may control the device 700. Code of the program executed by the processor 701 may be stored in the memory 703. The memory 703 may be a non-transitory computer-readable storage medium storing instructions that, when executed by the processor 701, configure the processor 701 to perform any one, any combination of any two or more, or all of the operations and methods described with reference to FIGS. 1 through 6.

FIG. 8 illustrates an example of a hardware structure of a model performing a method of compressing a neural network.

Referring to FIG. 8, a model 800 for performing a method of compressing a neural network may include a module 810 to perform fine-tuning of a first neural network or a base model (hereinafter, referred to as the fine-tuning module 810), a module (hereinafter, referred to as a compression module) 820 to compress delta weights of a task-specific model or a second neural network obtained by fine-tuning, and a module 830 to perform retraining of the task-specific model (hereinafter, referred to as the retraining module 830). Configurations of the fine-tuning module 810, the compression module 820 and the retraining module 830 of FIG. 8 are arbitrarily identified based on a logical operation performed in the model 800, and are limited by a structure of the model 800. As described with reference to FIG. 7, an operation, performed in the model 800, of a method of compressing a neural network may be performed by at least one processor.

The fine-tuning module 810 may receive a base model 801, which is pre-trained, and training data 802 for a predetermined purpose, and may correspond to a module to output a task-specific model by fine-tuning the base model 801 based on the training data 802. The fine-tuning module 810 may separate weights of the task-specific model into weights of the base model and delta weights and output weights of the base model and delta weights.

The compression module 820 may correspond to a module to output compressed delta weights by compressing delta weights received from the task-specific model. The compression module 820 may receive a preset standard on a degree of compression. For example, the compression module 820 may compress delta weights by pruning based on a pruning ratio included in the preset standard, and may compress the delta weights by quantizing the delta weights based on a quantization bit-width standard included in the preset standard.

The retraining module 830 may correspond to a module to retrain the task-specific model updated based on the compressed delta weights and the weights of the base model to satisfy a preset accuracy standard. The delta weights of the task-specific model output from the retraining module 830 may be input to the compression module 820 again and may be compressed based on the preset standard on the degree of compression. The task-specific model updated based on the compressed delta weights and the weights of the based model may be input to the retraining module 830 again.

Encoded data of delta weights of task-specific model 840, which satisfy the preset accuracy standard by retraining, may be output. Encoded data output from the model 800 may be stored in a database. For example, the task-specific model 840 may be obtained based on the base model 801 and the encoded data output from the model 800. More specifically, the delta weights corresponding to the task-specific model 840 may be restored based on the encoded data, and the task-specific model 840 may be restored by summing the delta weights and the weights of the based model 801. The task-specific model 840 may be implemented in a predetermined device.

FIG. 9 illustrates an example of a hardware structure of a model performing a method of compressing a neural network.

Referring to FIG. 9, a model 900 may receive a base model 901 and a plurality of training data sets 902 and may output a plurality of metadata sets 903, which are encoded data of delta weights corresponding to a plurality of task-specific models. A structure of the model 900 of FIG. 9 may correspond to the above-described structure of the model 800 of FIG. 8.

The plurality of metadata sets 903, which are the encoded data of the delta weights corresponding to the plurality of task-specific models output from the model 900, may be stored in a database 910. The database 910 may store the base model 901. The plurality of metadata sets 903 stored in the database 910 may be loaded into a user device or a different server implementing task-specific models and may be restored by the task-specific models based on weights of the base model 901.

The devices, processors, memories, I/O devices, device 700, processor 701, memory 703, I/O device 705, and other apparatuses, devices, units, modules, and components described herein with respect to FIGS. 1-9 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-9 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

What is claimed is:

1. A method with neural network compression, the method comprising:
generating a second neural network by fine-tuning a first neural network, which is pre-trained based on training data, for a predetermined purpose;
determining delta weights corresponding to differences between weights of the first neural network and weights of the second neural network;
compressing the delta weights;
retraining the second neural network updated based on the compressed delta weights and the weights of the first neural network; and
encoding and storing the delta weights updated by the retraining of the second neural network.

2. The method of claim 1, wherein the encoding and storing of the delta weights comprises:
determining whether to terminate the retraining of the second neural network based on a preset accuracy standard with respect to the second neural network; and
encoding and storing the delta weights updated by retraining of the second neural network based on a determination to terminate the retraining of the second neural network.

3. The method of claim 2, further comprising:
in response to a determination not to terminate the retraining of the second neural network, iteratively performing the compressing of the delta weights and the retraining of the second neural network updated based on the compressed delta weights and the weights of the first neural network.

4. The method of claim 1, wherein the encoding and storing of the delta weights comprises:
encoding the delta weights by metadata comprising position information of non-zero delta weights of the delta weights; and
storing the metadata corresponding to the second neural network.

5. The method of claim 1, wherein the compressing of the delta weights comprises performing pruning to modify a weight, which is less than or equal to a predetermined threshold, of the delta weights to be 0.

6. The method of claim 1, wherein the compressing of the delta weights comprises performing quantization to reduce the delta weights to a predetermined bit-width.

7. The method of claim 1, further comprising generating the second neural network, which is trained to perform the predetermined purpose, based on the delta weights, which are encoded and stored, and the weight of the first neural network.

8. A method with neural network compression, the method comprising:
generating a plurality of task-specific models by fine-tuning a base model, which is pre-trained corresponding to a plurality of training data sets for a plurality of purposes;
for each of the plurality of task-specific models, determining delta weights corresponding to differences between weights of the base model and weights of the task-specific model;
for each the plurality of task-specific models, compressing the determined delta weights based on a preset standard corresponding to the task-specific model; and
compressing and storing the plurality of task-specific models based on the compressed delta weights corresponding to the plurality of task-specific models.

9. The method of claim 8, wherein the compressing of the determined delta weights comprises performing pruning to modify a weight, which is less than or equal to the predetermined threshold, of the delta weights to be 0.

10. The method of claim 8, wherein the compressing of the determined delta weights comprises performing quantization to reduce the delta weights to a predetermined bit-width.

11. The method of claim 8, wherein the compressing and storing of the plurality of task-specific models comprises:
for each of the plurality of task-specific models, retraining the task-specific model updated based on the weights of the base model and the compressed delta weights corresponding to the task-specific model; and
for each of the plurality of task-specific models, encoding and storing delta weights corresponding to the task-specific model updated by the retraining.

12. The method of claim 11, wherein the encoding and storing of the delta weights comprises:
encoding the delta weights by metadata comprising position information of non-zero delta weights of the delta weights; and
storing the metadata corresponding to the task-specific models.

13. The method of claim 8, wherein the preset standard comprises either one or both of a standard on a pruning ratio and a standard on a quantization bit-width.

14. A non-transitory computer-readable storage medium storing instructions that, when executed by one or more processors, configure the one or more processors to perform the method of claim 1.

15. An apparatus with neural network compression, the apparatus comprising:
one or more processors configured to:
generate a second neural network by fine-tuning a first neural network, which is pre-trained based on training data, for a predetermined purpose;
determine delta weights corresponding to differences between weights of the first neural network and weights of the second neural network;
compress the delta weights;
retrain the second neural network updated based on the compressed delta weights and the weights of the first neural network; and
encode and store the delta weights updated by retraining of the second neural network.

16. The apparatus of claim 15, wherein, for the encoding and storing of the delta weights, the one or more processors are configured to:
determine whether to terminate the retraining of the second neural network based on a preset accuracy standard with respect to the second neural network; and
encode and store the delta weights updated by retraining of the second neural network based on a determination to terminate the retraining of the second neural network.

17. The apparatus of claim 16, wherein the one or more processors are configured to, in response to a determination not to terminate the retraining of the second neural network, iteratively perform the compressing of the delta weights and the retraining of the second neural network updated based on the compressed delta weights and the weights of the first neural network.

18. A method with neural network compression, the method comprising:
determining delta weights based on differences between weights of a pre-trained base neural network and weights of a task-specific neural network generated by retraining the pre-trained base neural network for a predetermined task;
updating the task-specific neural network by compressing the delta weights;
updating the compressed delta weights by retraining the updated task-specific neural network; and
encoding and storing the updated delta weights.

19. The method of claim 18, wherein the updating of the task-specific neural network comprises summing the weights of the base neural network and the compressed delta weights.

20. The method of claim 18, further comprising:
updating the pre-trained base neural network based on the stored delta weights; and
performing the predetermined task by implementing the updated base neural network.

21. The method of claim 20, wherein
the stored delta weights are stored in an external device, and
the implementing of the updated base neural network comprises loading the stored delta weights by a user device.
